(19) United States
(12) Patent Application Publication
(10) Pub. No.: US 2007/0280347 A1
(43) Pub. Date: Dec. 6, 2007

(54) VIDEO SIGNAL TRANSMITTING METHOD

(75) Inventor: MING-CHIH HSIEH, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/611,149

(22) Filed: Dec. 15, 2006

(30) Foreign Application Priority Data
Jun. 2, 2006 (CN) 200610060970.6

(51) Int. Cl. H04B 1/66

(52) U.S. Cl. 375/240.1

(57) ABSTRACT

An exemplary video signal transmitting method includes steps of: an apparatus receiving video images; coding and compressing the video images by an encoder; converting the coded compressed video images into electrical video signals by a central processing unit; detecting a network card of the apparatus to generate a control signal; and a control device receiving the control signal to select a digital model or an analog model for controlling the apparatus transmitting the video signals in a digital format or in an analog format. The video signal transmitting method can transmit video signals in digital format when the network is connected, or in analog format via A/V or S/V port when the network is not connected for preventing format errors in video signal transmissions.

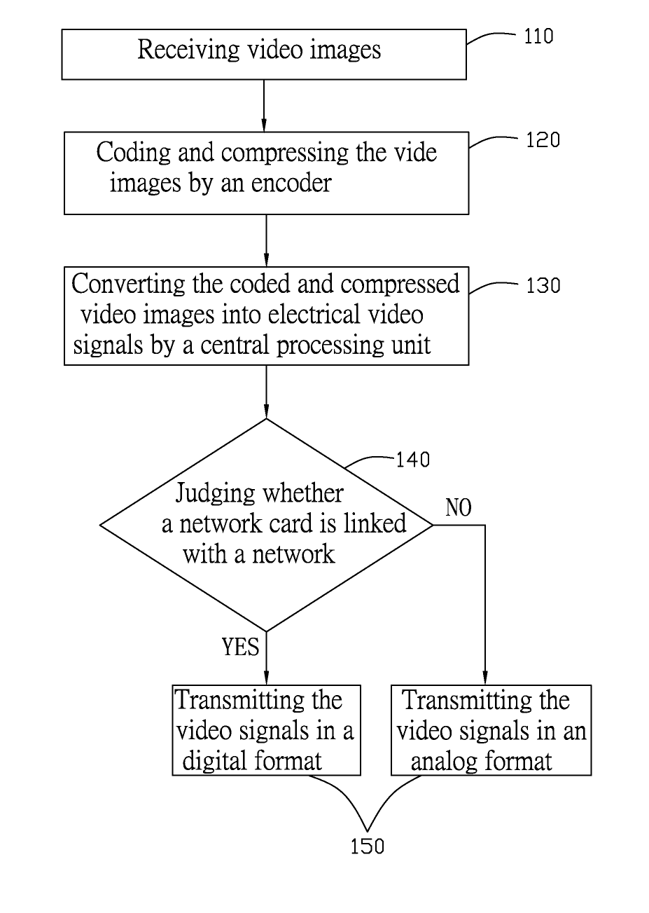

### BACKGROUND OF THE INVENTION

1. Field of the Invention

The present invention relates to video signal process methods, and particularly to a video signal transmitting method with transmission format automatically chosen.

2. Description of Related Art

The introduction of digital techniques for capturing and editing video images has led to improvements in the quality of images available to consumers and to greater flexibility for editors and producers.

Digital video cameras that capture images using arrays of pixels and compile those pixel images into a video signal represent the state of the art in video camera technology. These cameras are rugged, compact, and deliver high-quality video images. The vast majority of digital video cameras used by consumers and professionals can output both digital and analog video signals.

Video signals generated by the digital video cameras can be transmitted in a digital format to a network via a network card, and also can be transmitted in an analog format to other devices via an Audio/Video (A/V) port or an Separate Video (SV) port. Typically, the digital and analog formats are chosen manually according to need. Video signals transmission format errors may occur when the video signals are transmitted in a wrong format.

What is needed, therefore, is a circuit board which can automatically choose a correct transmission format for the video signals.

### SUMMARY OF THE INVENTION

An exemplary video signal transmitting method includes steps of: an apparatus receiving video images; coding and compressing the video images by an encoder; converting the coded compressed video images into electrical video signals by a central processing unit; detecting a network card of the apparatus to generate a control signal; and a control device receiving the control signal to select a digital model or an analog model for controlling the apparatus transmitting the video signals in a digital format or in an analog format, wherein if the network card is linked with a network and accordingly generates a working signal, the control device select the digital model for controlling the apparatus transmitting the video signals in a digital format via the network card; and if the network card does not generate the working signal, the control device select the analog model for controlling the apparatus transmitting the video signals in an analog format via an A/V port or an SV port.

Other advantages and novel features will become more apparent from the following detailed description when taken in conjunction with the accompanying drawing, in which:

### BRIEF DESCRIPTION OF THE DRAWING

The drawing is a flow diagram of one embodiment of a video signal transmitting method.

### DETAILED DESCRIPTION OF THE INVENTION

Referring to the drawing, a video signal transmitting method includes the following steps.

Step 110: an apparatus receiving video images from an imaging sensor or any other equipment;

Step 120: coding and compressing the video images by an encoder;

Step 130: converting the coded and compressed video images into electrical video signals by a central processing unit;

Step 140: detecting a network card of the apparatus to generate a control signal;

Step 150: a control device receiving the control signal to select a digital model or an analog model for transmitting the video signals in a digital format or an analog format.

In the above steps, if the network card is linked with a network and generates a “Link” signal, the control device select the digital model for controlling the apparatus transmitting the video signals in a digital format via the network card; and if the network card does not generate the “Link” signal, the control device select the analog model for controlling the apparatus transmitting the video signals in an analog format via an A/V port or an SV port.

In the foregoing description of the sub-steps, a “Speed” signal or an “Active” signal also can be detected instead of the “Link” signal.

The video signal transmitting method can transmit video signals in a digital format when the network is linked, or in an analog format via an A/V port or an S/V port when the network is not linked for preventing format errors in video signal transmissions.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A video signal transmitting method comprising steps of:
an apparatus receiving video images;
coding and compressing the video images by an encoder;
converting the coded compressed video images into electrical video signals by a central processing unit;
detecting a network card of the apparatus to generate a control signal; and
a control device receiving the control signal to select a digital model or an analog model for controlling the apparatus transmitting the video signals in a digital format or in an analog format,
wherein if the network card is linked with a network and accordingly generates a working signal, the control device select the digital model for controlling the apparatus transmitting the video signals in a digital format via the network card; and if the network card does not generate the working signal, the control device select the analog model for controlling the apparatus transmitting the video signals in an analog format via an A/V port or an SV port.

2. The video signal transmitting method as claimed in claim 1, wherein the working signal is a “Link” signal generated by the network card when the network is linked with the apparatus.

3. The video signal transmitting method as claimed in claim 1, wherein the working signal is an “Active” signal generated by the network card when the network is linked with the apparatus.

4. The video signal transmitting method as claimed in claim 1, wherein the working signal is a “Speed” signal generated by the network card when the network is linked with the apparatus.
